(19) United States
(12) Patent Application Publication
(10) Pub. No.: US 2024/0163614 A1
(43) Pub. Date: May 16, 2024

(54) EXCITER AND SPEAKER

(71) Applicant: FOSTER ELECTRIC COMPANY, LIMITED, Tokyo (JP)

(72) Inventor: Takayuki TABATA, Tokyo (JP)

(73) Assignee: FOSTER ELECTRIC COMPANY, LIMITED, Tokyo (JP)

(21) Appl. No.: 18/278,615

(22) PCT Filed: Feb. 21, 2022
(86) PCT No.: PCT/JP2022/006974

§ 371 Date: Aug. 23, 2023

(30) Foreign Application Priority Data
Mar. 1, 2021 (JP) 2021-031815

(51) Int. Cl. H04R 9/04; H04R 9/02

(52) U.S. Cl. CPC H04R 9/045; H04R 9/025; H04R 9/06; H04R 2440/05; H04R 2499/13

(57) ABSTRACT

An exciter and a speaker that can reduce a number of assembly processes by simplifying a fixing structure and that can reproduce high-quality sound by simply and surely attaching a voice coil to a vibration member. An exciter of the present disclosure includes a magnetic circuit fixed to a holding member, a voice coil, and an engaging member mounted to the voice coil. The engaging member includes an engaging portion engaging to an engaged portion provided to a vibration member, and a pressed portion to engage the engaging portion and the engaged portion.

### FIELD OF INVENTION

The present disclosure relates to exciters and speakers, and in particular, relates to exciters and speakers that are fixed to interior and exterior of vehicles.

### BACKGROUND

Conventionally, speakers which reproduce sound by vibrating a cone-shaped diaphragm are widely used for acoustic reproduction of music and sound. For example, this speaker is embedded and arranged in both front doors of a car.

In recent years, to create high-quality acoustic space inside a vehicle, a plurality of speakers is installed in limited space of the vehicle such as in front doors, in rear doors, in dashboards, and in a ceiling. Therefore, the speaker is required to have flexible installation position and to be space-saving. However, the speaker with a diaphragm requires installation space of certain size, and to maintain high-quality sound, the speaker itself must be large, making the flexible installation position and the space-saving difficult.

Accordingly, for example, as shown in the Patent Documents 1 to 3, an exciter which vibrates itself to vibrate interior material to which it contacts and which reproduces sound from the interior material is proposed.

### PRIOR ART DOCUMENT

### Patent Document

Patent Document 1: JP 5758021
Patent Document 2: JP 3953454
Patent Document 3: JP 2005-14793

### SUMMARY OF INVENTION

### Problems to be Solved by Invention

In such exciters, a voice coil must be surely fixed to a vibration component such as interior material. However, as the conventional technology described in the Patent Documents 1 and 2, for example, fixation using double-sided adhesive tape does not allow to directly press the vibration member and the voice coil when attaching the exciter. In particular, since a fixed portion of the vibration member and the voice coil is covered by a cylindrical magnetic circuit, said circuit prevent the double-sided adhesive tape from being pressed onto the vibration material, such that the voice coil could not be strongly fixed to the vibration member. Furthermore, in such exciters, since the voice coil is vibratably supported against the magnetic circuit and a frame thereof to enable the voice coil to vibrate, even if pressing force is applied to the magnetic circuit and the frame thereof when fixing the voice coil to the vibration member, the pressing force would not be transferred to the voice coil. Accordingly, there is a problem that it is difficult to vibrate the vibration member together with the voice coil if the voice coil and the vibration member are not in close contact, such that the vibration efficiency decreases and the sound quality decreases.

The conventional technology described in Patent Document 3 forms a joint member integrally to a part of the interior and exterior of the car that is the vibration member by injection molding and fixes the voice coil onto the joint member by screwing. Although the conventional technology has an advantage that the voice coil can be surely fixed to the vibration member via the frame without applying any force to the voice coil, there is a disadvantage that a male screw portion and a female screw portion must be provided to the joint member and the voice coil for screwing, complicating the structure. A screwing process requires to rotate the voice coil around the joint member for several times, and since the two cannot be fixed at the same time, the workability of the assembly process is worse than the conventional technology using double-sided adhesive tape. Furthermore, cost for preparing special joint member is high. In particular, in a case of attaching the exciter afterward in response to a user's demand, there is a problem that the joint member cannot be integrally formed to the part of the interior and exterior of the car, requiring time and effort to install the exciter.

The present disclosure is proposed to address the above-described problem. The objective of the present disclosure is to provide an exciter and a speaker that can reduce a number of assembly processes by simplifying a fixing structure and that can reproduce high-quality sound by simply and surely attaching a voice coil to a vibration member.

### Means to Solve the Problem

An exciter of the present disclosure has the following configuration.
(1) a magnetic circuit fixed to a holding member;
(2) a voice coil;
(3) an engaging member mounted to the voice coil;
(4) the engaging member includes: an engaging portion engaging to an engaged portion provided to a vibration member, and a pressed portion to engage the engaging portion and the engaged portion.

In the present disclosure, following configuration may be employed.
(1) the exciter further has an insertion portion for a press fit that is capable of pressing the pressed portion;
(2) the insertion portion is a through hole penetrating a central portion of the magnetic circuit;
(3) a pressing portion that presses the pressed portion is provided in the magnetic circuit or the holding member of the magnetic circuit;
(4) the engaging member includes: an outer wall to which the voice coil is mounted, a bottom abutting with the vibration member, and a protrusion protruding toward the magnetic circuit, and the pressed portion is provided in the protrusion.
(5) the engaging portion is formed on the outer wall of the engaging member;
(6) a cushioning material is formed on a surface of the engaging member;
(7) the voice coil is supported by the holding member by a damper;
(8) the vibration member including the engaged portion is provided, and the exciter is mounted on the vibration member;
(9) the engaging portion is constructed by an engaging claw or an engaging hole, and the engaged portion is constructed by an engaging hole or an engaging claw corresponding to the engaging portion;
(10) the engaged portion is formed by a voice coil mounting portion protruding from the vibration member, and the engaging member is attached to the voice coil mounting portion;
(11) a concaved portion or a convex portion is formed on a bottom of the engaging member and/or the vibration member.

### Effect of Invention

According to the present disclosure, mounting the engaging member on the voice coil enables to simplify the fixing structure and reduce the number of the assembly processes. Furthermore, by surely fixing the holding member of the magnetic circuit to the vibration member, the exciter and the speaker that can reproduce high-quality sound can be provided.

### BRIEF DESCRIPTION OF DRAWINGS

FIG. 1 is a perspective view illustrating the entire assembly condition of the first embodiment.

FIG. 2 is a rear perspective view illustrating the assembly condition of the first embodiment.

FIG. 3 is an exploded perspective overall view of the first embodiment.

FIG. 4 is an exploded perspective view illustrating the vibration member and the voice coil of the first embodiment from which the magnetic circuit is removed.

FIG. 5 is a vertical cross-sectional view illustrating the vibration member and the voice coil of the first embodiment.

FIG. 6 is an enlarged perspective view illustrating the voice coil mounting portion of the first embodiment.

FIG. 7 is an exploded perspective view of the magnetic circuit and the engaging member of the first embodiment viewed from below.

FIG. 8 is an exploded perspective view of the magnetic circuit and the engaging member of the first embodiment viewed from above.

FIG. 9 is a horizontal cross-sectional view illustrating the fixed state of the magnetic circuit of the first embodiment.

FIG. 10 is a horizontal cross-sectional view illustrating the usage state of the press fit of the first embodiment.

FIG. 11 is an exploded perspective view illustrating the voice coil and the engaging member of the second embodiment.

FIG. 12 is a horizontal cross-sectional view illustrating the usage state of the press fit of the second embodiment.

### EMBODIMENTS

### 1. First Embodiment

[1-1. Configuration]

(1) Exciter and Vibration Member

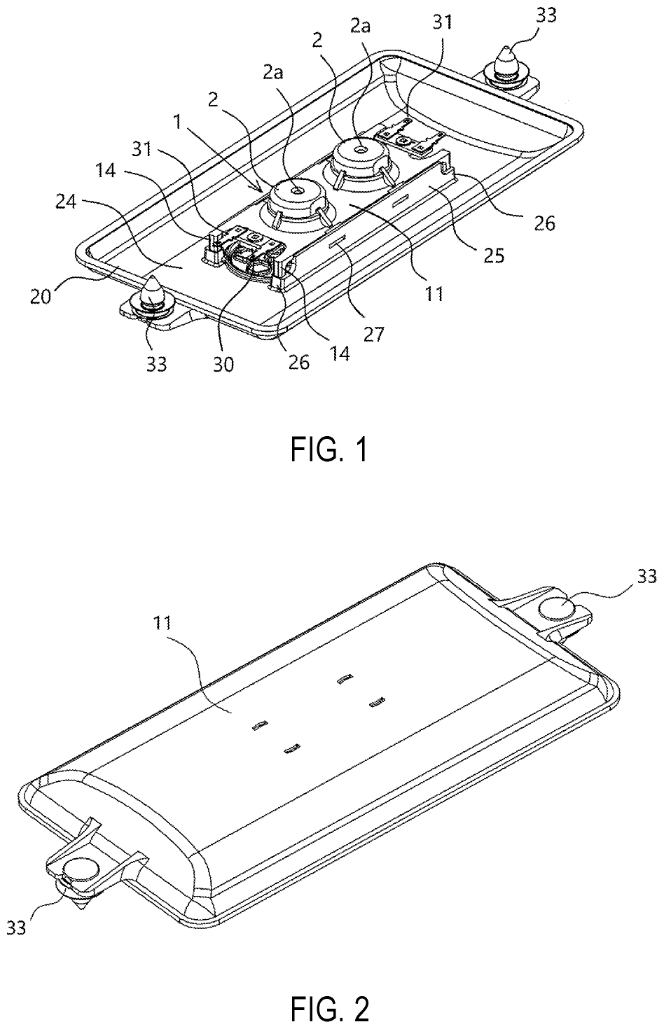

As illustrated in FIG. 1, an exciter 1 of the present embodiment is fixed to a vibration member 20. For example, the vibration member 20 is an interior or exterior for vehicles such as pillars, doors, dashboards, instrument panels, console boxes, and ceilings. Since the exciter 1 of the present embodiment is used by attaching it to vehicles and the like in various direction, the vertical positional relationship of the exciter 1 varies, however, for the sake of explanation, in below, the vibration-member-20 side is described as the lower side and the exciter-1 side is described as the upper side.

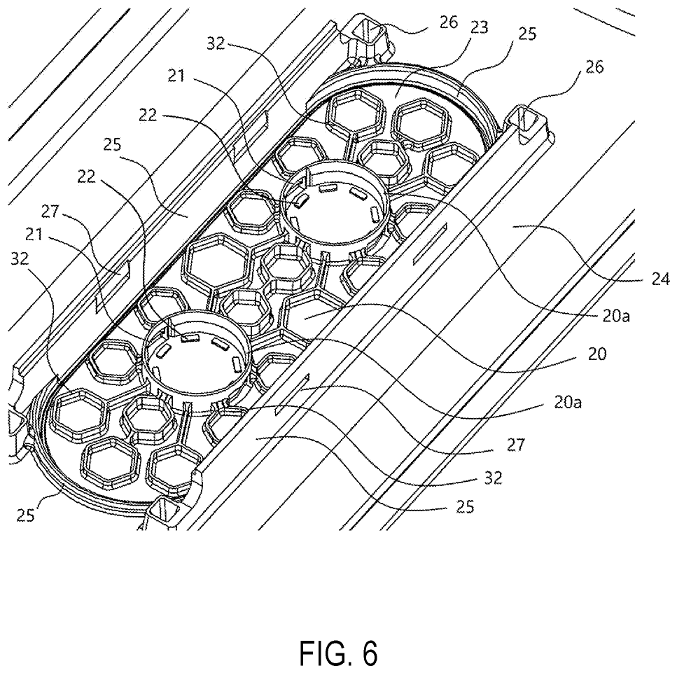

Configuration of the vibration member 20 is not particularly limited if the vibration member 20 can be mounted in the exciter 1 of the present embodiment. As illustrated in FIG. 6, the vibration member 20 includes a voice coil 3 forming the exciter 1 and a voice coil mounting portion 20a for mounting a coil bobbin 8. In the present embodiment, the voice coil mounting portion 20a is a cylindrical frame which is the coil bobbin 8 with the lower side fit and the upper side opened, however, the shape of the frame is not limited to a cylinder and may be tubular, fan-shape, or bar-shape. In the present embodiment, the exciter 1 with two magnetic circuits 2 is mounted in the vibration member 20, and therefore, two voice coil mounting portion 20a is provided in the vibration member 20 according to the number of the voice coil 3. Convex portions 22 protruding toward the voice-coil-3 side is formed inside the voice coil mounting portion 20a in an annular dotted line. As described later, in the present embodiment, since an engaging member 9 to which the voice coil 3 is mounted is mounted inside the voice coil mounting portion 20a, the convex portion 22 is formed inside the voice coil mounting portion 20a. If the engaging member 9 is mounted outside the voice coil mounting portion 20a, the convex portion 22 may be formed outside the voice coil mounting portion 20a of the vibration member 20.

(2) Magnetic Circuit and Voice Coil

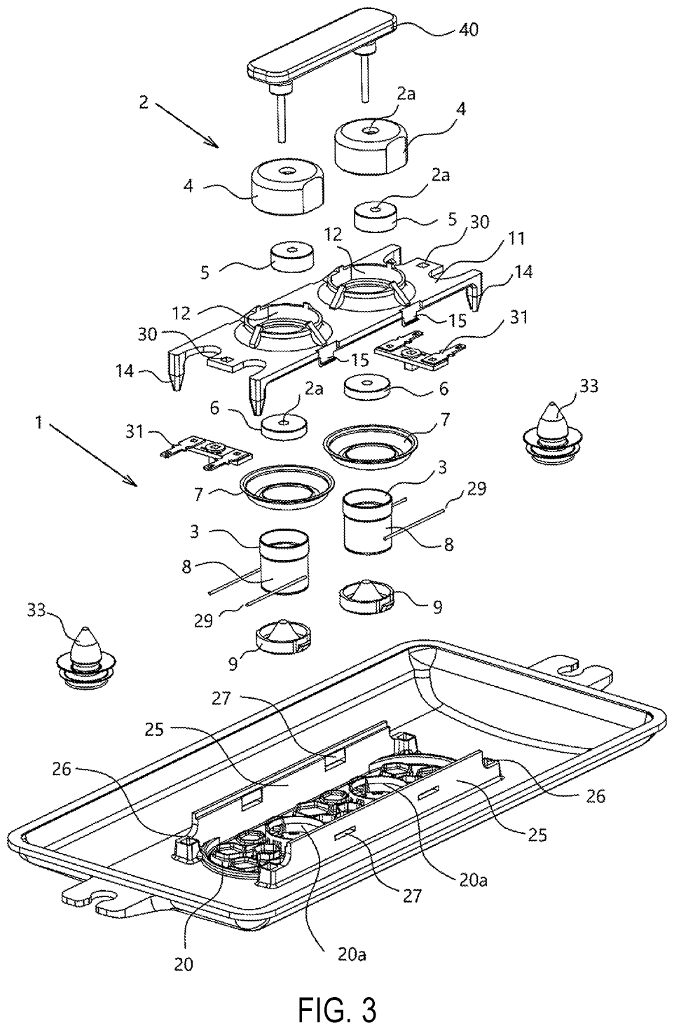

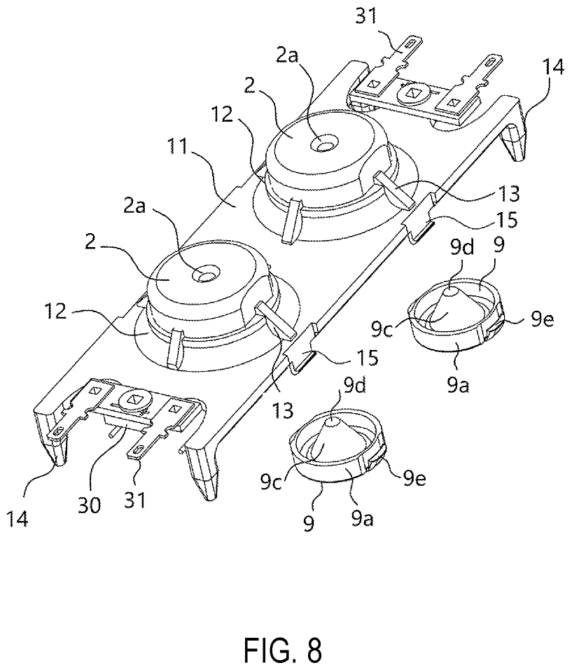

As illustrated in FIG. 3, the exciter 1 of the present embodiment includes the magnetic circuit 2 and the voice coil 3. As illustrated in FIGS. 1 and 8, the magnetic circuit 2 is fixed by a frame-shaped holding member 11. In the present embodiment, two magnetic circuits 2 and two voice coils 3 are provided in single holding member 11, however, single or multiple magnetic circuits 2 and voice coils 3 may be provided. In the present embodiment, the magnetic circuit 2 is an inner-magnet type magnetic circuit, however, the magnetic circuit 2 may be an outer-magnet type magnetic circuit. As illustrated in FIG. 3, the magnetic circuit 2 includes a yoke 4, a magnet 5, and a pole piece 6.

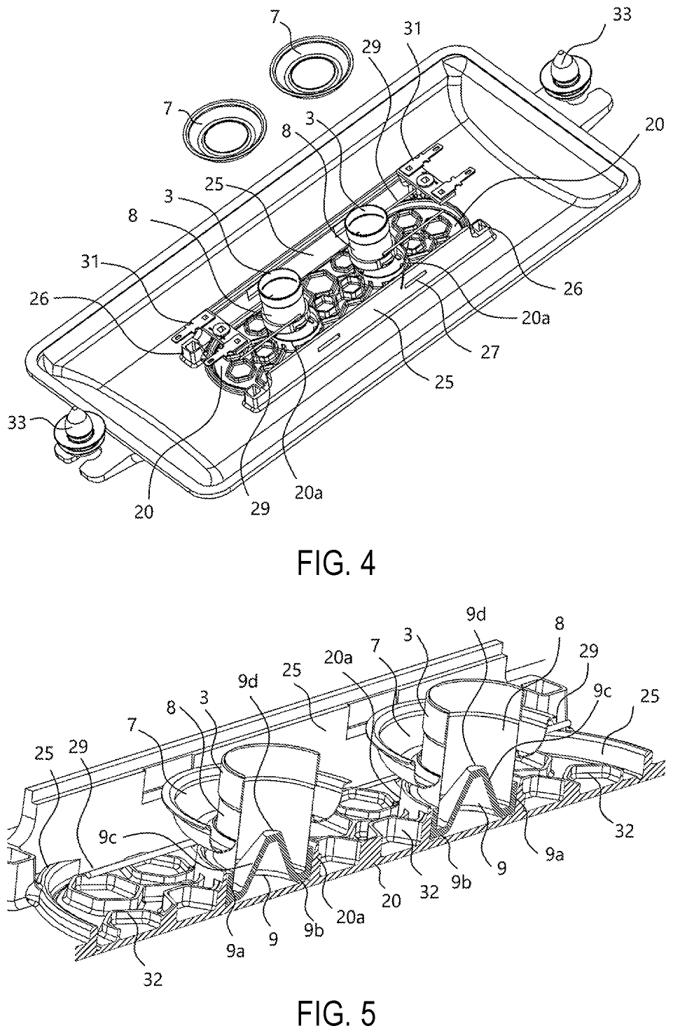

As illustrated in FIGS. 3 to 5, the voice coil 3 includes a coil bobbin 8, however, the voice coil 3 may not include the coil bobbin 8 and be formed only by itself. In the present embodiment, two voice coils 3 are employed, however, one voice coil 3 or three or more voice coils 3 may be employed. The coil bobbin 8 is a cylindrical member around which the voice coil 3 is wound, and a lead wire 29 is withdrawn from both ends of the voice coil 3. The lead wire 29 is connected to a connection terminal 31.

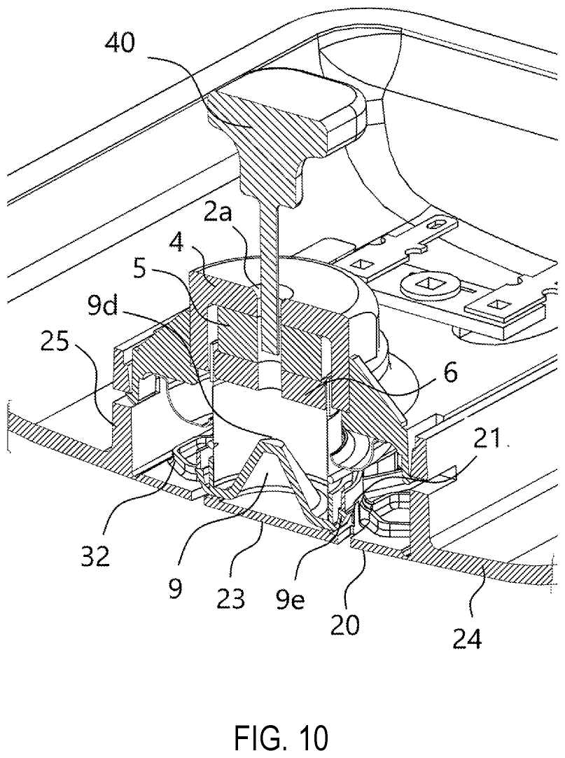

As illustrated in FIG. 10, the yoke 4 is a bottomed cylinder with an opening on the voice-coil-3, and a through hole is provided at the central portion thereof. The magnet 5 and the pole piece 6 are stacked arranged vertically inside the yoke 4. The pole piece 6 is also called a plate and is circular, and a through hole is provided at the central portion thereof. As illustrated in FIG. 10, the voice coil 3 is inserted into a magnetic gap formed among the yoke 4, the magnet 5, and the pole piece 6. As illustrated in FIG. 10, the through hole provided at the central portion of the yoke 4, the magnet 5, and the pole piece 6 becomes an insertion portion 2a of the press fit 40 which can press a pressed portion 9d provided in the engaging member 9 described later. Note that, in the present embodiment, the insertion portion 2a is provided in the magnetic circuit 2, however, the insertion portion 2a can be provided in the magnetic circuit 2 or the holding member 11 if they are the member that forms the exciter 1.

(3) Holding Member

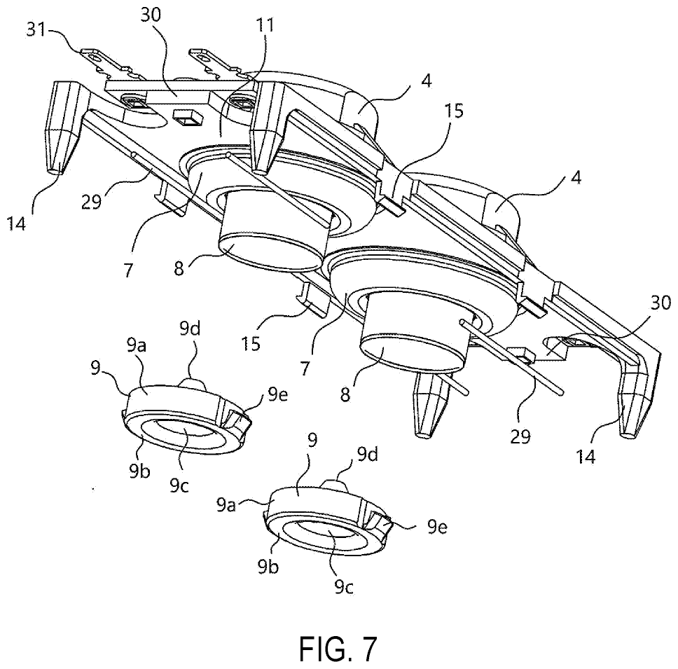

As illustrated in FIG. 3, the holding member 11 is a frame that holds the magnetic circuit 2. As illustrated in FIGS. 7 and 8, the holding member 11 includes a magnetic circuit mounting portion 12, reinforcement ribs 13, legs 14, and an engaging protrusion 15. The magnetic circuit mounting portion 12 is a cylindrical opening provided at the central portion of the holding member 11 and is fixed in a state the magnetic circuit 2 is fit therein. As illustrated in FIG. 6, two magnetic circuit mounting portions 12 are arranged along the length direction of a vibration surface 23 of the vibration member 20 described later at position corresponding to the voice coil mounting portions 20a provided on the vibration surface 23.

As illustrated in FIG. 8, the reinforcement rib 13 is provided around the magnetic circuit mounting portion 12 to reinforce the magnetic circuit mounting portion. The reinforcement rib 13 is triangular and is provided at four directions between an outer surface of the cylindrical magnetic circuit mounting portion 12 and an uppers surface of the holding member 11. In the present embodiment, the magnetic circuit 2 and the magnetic circuit mounting portion 12 are fixed by adhesive, however, they can be fixed by, for example, press fitting and insert molding.

As illustrated in FIGS. 3 and 7, the legs 14 protruding toward the vibration-member-20 side are provided at four corners of the holding member 11. The leg 14 is generally called a guide pin and is provided at position corresponding to a positioning portion 26 provided in the vibration member 20. In the present embodiment, four legs 14 are provided, however, the number of the legs 14 can be changed depending on the size of the holding member 11. The leg 14 has a tapered lower end to facilitate insertion into the positioning portion 26.

As illustrated in FIGS. 3, 7, and 8, the engaging protrusion 15 is provided to the holding member 11 to fix the holding member 11 to the vibration member 20. Two engaging protrusions 15 are provided on each side of the holding member 11 along the length direction so as to face engaging holes 27 of dividing portions 25. A lower end of the engaging protrusion 15 protrudes outward forming a key-shape. The engaging protrusion 15 is elastically deformable and can be easily fixed in the direction orthogonal to the length direction of the dividing portion 25. The shape of the engaging protrusion 15 is not limited and the number of the engaging protrusion may be increased or decreased as appropriate. The engaging protrusion 15 may not be provided, and the holding member 11 may be adhered and fixed to the leg 14.

(4) Engaging Member

As illustrated in FIG. 7, for example, the engaging member 9 is a cap-shaped member on which diameter at the magnetic-circuit-2 side is reduced. Although the engaging member 9 is formed by resin material with relatively high rigidity, cushioning material may be provided on surface thereof by insert-molding thin elastomer film with low rigidity that does not interfere vibration transmission or by employing thick elastomer material with high rigidity. The cushioning material may be provided not only by insert-molding but also by adhesion. The engaging member 9 includes an outer wall 9a to which the voice coil is 3 mounted, a bottom 9b abutting with the vibration member 20, and a protrusion 9c which protrudes toward the magnetic circuit 2 and is inserted into the coil bobbin 8.

The engaging member 9 may be mounted to the coil bobbin 8 at an inner or outer surface of the outer wall 9a, and in the present embodiment, an end of the coil bobbin 8 is fit to the inner surface of the outer wall 9a because the dimension can be easier to measure and more precise for the inner surface. By fixing the outer surface of the coil bobbin 8 and the inner surface of the outer wall 9a using adhesive, the coil bobbin 8 and the engaging member 9 are integrated.

An engaging portion 9e is formed on the outer wall 9a and engages with an engaged portion 21 provided in the voice coil mounting portion 20a of the vibration member 20 described later. The engaging portion 9e is formed by an engaging claw or an engaging hole, and the engaged portion 21 provided in the vibration member 20 is formed by an engaging hole or an engaging claw corresponding to the engaging portion 9e. By engaging the engaging portion 9e and the engaged portion 21, the voice coil 3 is fixed to the voice coil mounting portion 20a of the vibration member 20 via the coil bobbin 8. In the present embodiment, the engaging portion 9e is formed by an engaging claw. An upper end of the engaging claw protrudes outward forming a key-shape. The engaging claw is elastically deformable and can deform in the central direction. The shapes of the engaging portion 9e and the engaged portion 21 are not limited and the numbers of the engaging portion 9e and the engaged portion 21 may be increased or decreased as appropriate.

As illustrated in FIG. 7, the bottom 9b is annular and is abutted to a vibration surface 23 of the vibration member 20. The surface of the vibration member 20 contacting a lower surface of the bottom 9b may be plain, however, convex portions 22 protruding toward the vibration-member-20 side on the lower surface of the bottom 9b in an annular dotted line. The convex portion may not be provided in an annular dotted line, and the shape and type of the convex portion are not limited. By providing the convex portion on the surface abutting the vibration member 20, an area where the bottom 9b and the vibration member 20 can be minimized as required, so that the coil bobbin 8 and the bottom 9b can closely contact with each other to ensure that the vibration of the voice coil 3 is transmitted to the vibration member 20. Instead of the convex portions on the abutting surface of the bottom 9b, concaved portions may be formed or both the convex portions and concaved portions may be formed if the area where the bottom 9b and the vibration member 20 can be minimized and the coil bobbin 8 and the bottom 9b closely contact with each other.

As illustrated in FIG. 8, the protrusion 9c has a cap-shape with a tapered surface protruding toward the magnetic-circuit-2 side with reduced diameter. The shape of the protrusion 9c is not limited to the cap-shape with a tapered surface, and may be formed by various shapes such as a conical shape, a pyramidal shape, and a stepwise shape. A pressed portion 9d with small area in parallel with the surface of the vibration member 20 is provided in an upper portion of the protrusion 9c. As illustrated in FIG. 10, when the pressed portion 9d is pressed toward the vibration-member-20 side from the magnetic-circuit-2 side by the press fit 40, the engaging member 9 can be pressed to the vibration surface 23 of the vibration member 20 while elastically deforming the engaging portion 9e of the engaging member 9, so that the engaged portion 21 provided in the vibration member 20 and the engaging portion 9e of the engaging member 9 can be engaged. The pressed portion 9d may not necessarily be provided in the upper portion of the protrusion 9c if the pressed portion 9d is provided at a position that can be pressed when the press fit 40 is inserted from the insertion portion 2a provided in the magnetic circuit 2, and may be provided at any of the outer wall 9a, the bottom 9b, or the protrusion 9c of the engaging member 9. The pressed portion 9d may not necessarily be the plain with small area as illustrated, and may be sufficient if the engaging member 9 elastically deforms when being pressed and the engaged portion 21 provided in the vibration member 20 and the engaging portion 9e can be engaged.

(5) Damper

The voice coil 3 is supported by the holding member 11 by a damper 7. The damper 7 is, for example a ring-shaped member, and the outer circumference of the damper 7 is fixed to the holding member 11 and the inner circumference of the damper 7 is fixed to the outer circumference of the coil bobbin 8. The damper 7 may be formed of resin material or metal material. When forming the damper 7 by resin material, a thermoplastic polyurethane elastomer (TPU) is suitable, however, it is not limited thereto. The damper 7, the coil bobbin 8 (the voice coil 3), and the holding member 11 may be fixed using adhesion, heat welding, and other fixing method.

(6) Vibration Member

As illustrated in FIG. 3, a fixing component 33 for fixing the vibration member 20 to the vehicle is provided in the vibration member 20 of the present embodiment. The vibration member 20 is screwed or crimped to the vehicle using a notch provided in the fixing component 33. The shape of the fixing component 33 is not limited and the number of the fixing component 33 may be increased or decreased as appropriate. The vibration member 20 may be fixed, for example, using screwing without providing the fixing component 33.

As illustrated in FIG. 6, the vibration member 20 includes the vibration surface 23 and a non-vibration surface 24. The vibration surface 23 is a thin portion provided in the vibration member 20 and vibrates when reproducing acoustic signal. The vibration surface 23 of the first embodiment has a track shape which is thin along the outer shape of the vibration member 20 (oval shape in which two sides in the length direction is straight and both end is semi-circular).

The non-vibration surface 24 is a portion thicker than the vibration surface 23, is provided around the vibration member 20 to surround the vibration surface 23, and does not vibrate even when the acoustic signal is reproduced. However, since the non-vibration surface 24 is provided in a part of the vibration member 20 together with the vibration surface 23, when the vibration surface 23 vibrates during the acoustic signal reproduction, the vibration may be transmitted to the non-vibration surface 24. In the present disclosure, the non-vibration surface 24 means a portion which vibrates less than the vibration surface 23 and substantially does not affect the reproduction characteristic of the acoustic signal during the acoustic signal reproduction.

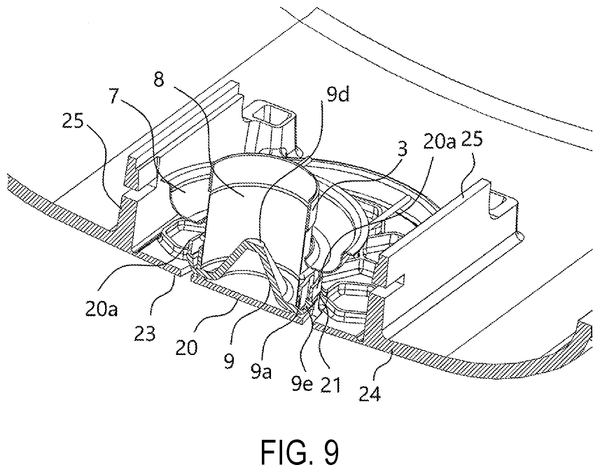

The vibration member 20 includes the dividing portion 25 that divides the vibration surface 23 and the non-vibration surface 24 and suppresses the vibration transmission from the vibration surface 23 to the non-vibration surface 24 during the acoustic signal reproduction. In the present embodiment, the dividing portion 25 is formed a rib-shape protruding toward the opening side (upward) of the vibration member 20 rather than the non-vibration surface 24. Although it is not necessary to form the dividing portion 25 all around the vibration surface 23, from the viewpoint of stabilizing the performance, it is preferable to form the dividing portion 25 all around the vibration surface 23. In the present embodiment, the dividing portion 25 is provided all around the vibration surface 23 with a track-shape, and among them, the dividing portion 25 that is smaller in height is provided at an arc portion at both end of the vibration surface 23 in the length direction as illustrated in the cross-section of FIG. 5. Furthermore, as illustrated in FIG. 6, a rib-shaped dividing portion 25 protruding to the height of several times higher than the thickness of the non-vibration surface 24 at two side along the length direction of the vibration surface 23. As illustrated in FIGS. 3, 9, and 10, since the holding member 11 is fit and mounted inside the tall rib-shaped dividing portion 25 provided in the two sides in the length direction, an upper portion of the surface of the dividing portion 25 at the vibration-surface-23 side is inclined toward the non-vibration-surface-24 side, to improve the fitting workability.

As illustrated in FIGS. 3 to 6, a positioning portion 26 for accurately positioning the vibration member 20 to the holding member 11 is provided in the vibration member 20. The positioning portion 26 is a rectangular tubular member with an opened top and is provided on the non-vibration surface 24. An inner wall of the tubular member of the positioning portion 26 is an inclined surface that spreads upward. The positioning portion 26 is provided outside the four corners of the vibration surface 23, that is, at the ends of two sides of the tall rib-shaped dividing portion 25. The engaging hole 27 is provided to the vibration member 20 to fix the holding member 11 to the vibration member 20. The engaging hole 27 is provided landscape in the tall rib-shaped dividing portion 25 along the surface of the vibration member 20. In the present embodiment, since two tall dividing portions 25 are linearly provided to sandwich the vibration surface 23, two engaging holes 27 are provided for each dividing portions 25 along the longitudinal direction.

As illustrated in FIG. 8, a terminal fixing portion 30 is provided in the holding member 11 to connect the lead wire 29 of the voice coil 3 to the external acoustic equipment. The terminal fixing portion 30 can horizontally fix a connection terminal 31. The connection terminal 31 may be fixed by press-fitting, adhesion, heat welding, and the like, as appropriate. The lead wire 29 of the voice coil 3 is connected to each of two metal connection terminal 31 of the terminal fixing portion 30.

As illustrated in FIGS. 5 and 6, a damping portion 32 may be formed on the vibration surface 23 of the vibration member 20. By forming multiple damping portions 32 and changing the shapes or sizes of the damping portions 32 between the central portion and the peripheral portion of the vibration surface 23, the resonance of the vibration surface 23 can be controlled. The tall damping portion 32 is provided at the central line of the vibration surface 23 in the length direction to improve the rigidity in the length direction. In the present embodiment, the hexagonal damping portion 32 is formed, and the hexagonal damping portion 32 and the voice coil mounting portion 20a may be connected by a linear rib portion.

[1-2. Action of Embodiment]

As illustrated in FIG. 1, the exciter 1 of the present embodiment is fixed to the vibration member 20 that is the interior and exterior of a vehicle. The cap-shaped engaging member 9 is mounted on the lower end of the coil bobbin 8 of the voice coil 3 forming the exciter 1. The coil bobbin 8 and the engaging member 9 are adhered by inserting the conical protrusion 9c into the coil bobbin 8 and inserting the lower end of the coil bobbin 8 into the outer wall 9a provided in the outer circumference of the protrusion 9c. In detail, the inner surface of the outer wall 9a is adhered to the outer surface of the coil bobbin 8 to fix the engaging member 9 to the coil bobbin 8. In such a state, the claw-shaped engaging portion 9e protrudes and extends from the outer wall 9a of the engaging member 9 beyond the outer surface of the coil bobbin 8.

In such a state, the exciter 1 is fixed to the vibration member 20. This fixing process is performed by inserting the legs 14 provided at four corners of the holding member 11 into the positioning portion 26 of the vibration member 20 to position the vibration member 20 and the holding member 11. The positioned vibration member 20 and the holding member 11 are fixed by engaging the engaging protrusion 15 of the holding member 11 and the engaging hole 27 of the vibration member 20.

When the holding member 11 is fixed to the vibration member 20, since the voice coil 3 and the coil bobbin 8 of the exciter 1 are attached to the magnetic circuit 2 via the damper 7, the pressing force to mount the holding member 11 to the vibration member 20 would not be directly applied, and the engaging member 9 provided at the lower end of the coil bobbin 8 cannot be surely fixed to the vibration member 20. That is, the bottom 9b of the engaging member 9 does not contact the vibration surface 23 of the vibration member while contacting the upper portion of the voice coil mounting portion 20a or slightly being fit inside the upper portion of the voice coil mounting portion 20a.

In this state, the press fit 40 is inserted into the insertion portion 2a provided in the magnetic circuit 2. Then, when the pressed portion 9d that is a tip of the protrusion 9c of the engaging member 9 is pressed, force is applied in the engaging member 9 from above, and the engaging member 9 is pressed inside the voice coil mounting portion 20a together with the coil bobbin 8 mounted to the engaging member 9. As a result, the claw-shaped engaging portion 9e expanding around the outer circumference of the engaging member 9 is pressed and descends inside the voice coil mounting portion 20a along the inner surface thereof, and when reaching the hole-shaped engaged portion 21 provided in the voice coil mounting portion 20a, expands due to elasticity thereof and engages with the engaged portion 21. Accordingly, the lower end of the coil bobbin 8 is engaged inside the voice coil mounting portion 20a, and the voice coil 3 and the vibration member 20 are fixed. In this state, the engaging member 9 and the vibration member 20 apply pressing force to each other and are held in close contact.

Furthermore, in the present embodiment, since the cushioning material such as elastomer is provided on the surface of the engaging member 9, when the engaging member 9 and the vibration member 20 are fixed, the cushioning material of the bottom 9b of the engaging member 9 elastically deforms and is press-bonded, so that the bottom 9b of the engaging member 9 and the surface of the vibration member 20 closely contact with each other due to said stress.

[1-3. Effect of Embodiment]
(1) The present embodiment has the configuration in which the voice coil 3 is attached to the holding member 11 and is unitized together with the magnetic circuit 2. Therefore, compared with the conventional configuration in which a joint member and a voice coil are screwed, work and time to fix the exciter 1 to the vibration member 20 can be omitted, facilitating the work to attach the exciter 1. Furthermore, the fixed structure can be simplified and the number of assembly processes can be reduced, reducing the cost for attaching the exciter 1. In addition, the engaging member 9 and the vibration member 20 can be surely fixed while applying pressing force to each other. In this case, since the engaging member 9 and the vibration member 20 has high adhesion, the vibration of the voice coil 3 can be surely transmitted to the vibration member 20 via the engaging member 9.
(2) The present embodiment can directly apply force to the pressed portion 9d of the engaging member 9 by utilizing the press fit 40 when adhering and fixing the exciter 1. As a result, the engaging member 9 is strongly pressed to the vibration member 20 via an adhering member 10. In the present embodiment, since the voice coil 3 can be surely fixed to the vibration member 20 via the engaging member 9, the vibration efficiency of the exciter 1 is improved and the acoustic signal of high frequency can be reproduced. Furthermore, since the pressed portion 9d of the engaging member 9 is pressed by the press fit 40 when fixing the exciter 1, deformation, damage, and disconnection due to bottoming of the voice coil 3 (bobbin and wire material) can be prevented. Therefore, the prevention of the bottoming can improve the reliability of the exciter 1 at the time of adhesion and fixing and improves the durability of the product.
(3) Since the engaging member 9 can be pressed between the exciter 1 and the vibration member 20 through the insertion portion 2a formed at the center of the magnetic circuit 2 without any intervening material for fixing the two, the two can be strongly fixed without applying excessive force to the voice coil 3 and the vibration member 20. As a result, the end of the voice coil 3 and the surface of the vibration member 20 where it is difficult to apply force as they are surrounded by the magnetic circuit 2 and the holding member 11 can be surely fixed.
(4) Since the upper portion of the protrusion 9c of the engaging member 9 protrudes toward the magnetic-circuit-2 side, the pressed portion 9d can be pressed easily and the force is easily transmitted to the bottom 9b when adhering and fixing the exciter 1. As a result, the engaging member 9 can be more strongly pressed downward when adhering and fixing the exciter 1, and the voice coil 3 can be more surely fixed to the vibration member 20. Furthermore, by providing a taper, the surfaces can be surely abutted regardless of the shape of the other and the length of the press fit 40 can be made longer or shorter.
(5) By fitting the engaging portion 9e provided in the holding member 11 to the engaged
portion 21 of the vibration member 20, the magnetic circuit 2 can be easily fixed to the holding member 9 without using tools or adhesive.
(6) Since the cushioning material is formed on the surface of the engaging member 9, cushioning sound and buzzing sound between the voice coil 3 and the engaging member 9 can be prevented.

(7) When fixing the exciter 1, the engaging member 9 receives the force required for the fixing and transmits the force to the vibration member 20. Therefore, it is possible to prevent excessive load to be applied to the damper 7 at the time of fixing.
(8) Since the convex portion 22 is provided on the bottom 9b of the engaging member 9 or inside or outside the voice coil mounting portion 20a of the vibration member 20, the surface area where the voice coil 3 and the vibration surface 23 abut with each other can be minimized as required, so that the voice coil 3 and the bottom 9b can closely contact with each other to ensure that the vibration of the voice coil 3 is transmitted to the vibration member 20.

### 2. Second Embodiment

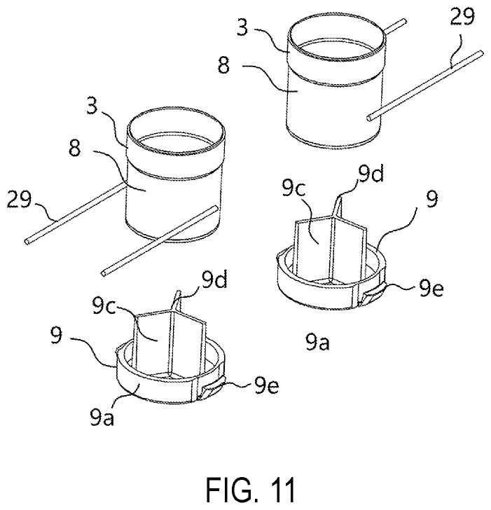

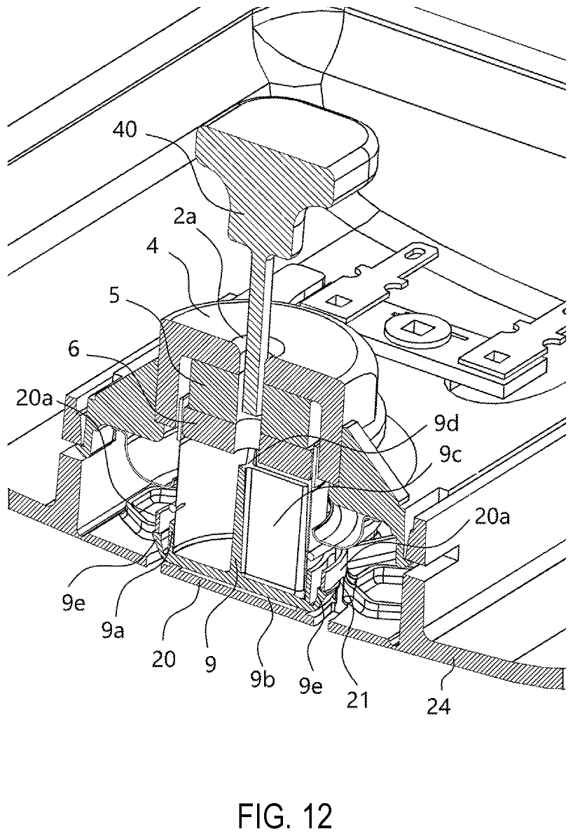

A second embodiment has an engaging member 9 with configuration different from that of the first embodiment. In the second embodiment, as illustrated in FIG. 11, the protrusion 9c of the engaging member 9 has a rib-shape. As illustrated in FIG. 12, since the rib-shaped protrusion 9c reaches near the lower portion of the magnetic circuit 2 from the bottom 9b of the engaging member 9, an upper end of the rib-shaped protrusion 9b, that is, the end of the rib-shaped protrusion 9b at the magnetic-circuit-2 side forms the pressed portion 9d.

Also in the second embodiment, by inserting the press fit 40 into the insertion portion 2a provided in the magnetic circuit 2 and pressing the pressed portion 9d at the top of the protrusion 9c by the tip of the press fit 40, the engaging member 9 is pressed inside the cylindrical voice coil mounting portion 20a, so that the engaging portion 9e and the engaged portion 21 are engaged and the voice coil 3 is fixed to the vibration member 20 via the engaging member 9. Note that the shape of the rib provided in the engaging member 9 may be radial, cross-shape, or any other shape.

In the second embodiment with such a configuration, the voice coil 3 and the vibration member 20 can be fixed by not pressing the magnetic circuit 2 but pressing the vibration-member-2 side. Therefore, deformation, damage, and disconnection due to bottoming of the voice coil 3 can be prevented, and the reliability of the exciter 1 at the time of adhesion and fixing can be improved and the durability of the product is improved. Also in the second embodiment, the fixed structure of the exciter 1 can be simplified and the number of assembly processes can be reduced, reducing the cost for attaching the exciter 1. Furthermore, since the pressed portion 9d on the rib-shaped upper portion can be directly pressed by the lower portion of the magnetic circuit 2 without using separate press fit 40, number of components for mounting the holding member 11 to the vibration member 20 is reduced and the assembling is facilitated.

### 3. Other Embodiment

As described above, although several embodiments of the present disclosure are described, the embodiments are not intended to limit the scope of claims, and as cited below, the embodiments can be implemented by various forms without departing from the abstract of the invention, and various omission, replacement, and modification may be made. Furthermore, these embodiments, combination, and modification thereof are included in the scope and abstract of the invention, and are included in the invention described in the scope of the claims. In below, example embodiments included in present disclosure will be described.
(1) The vibration member 20 is not limited to a member for vehicles and may be any member in the space to hear sound to which the exciter 1 can be fixed, such as walls of buildings and furniture such as chairs.
(2) The engaging member 9 may not be a member separate from the voice coil 3 and may be formed together with the voice coil 3 such as by insert molding. Furthermore, the voice coil 3 may not be formed with the coil bobbin 8 and may be formed of single voice coil.
(3) The outer wall 9a of the engaging member 9 may not be a cylinder a wall all around and may be a plurality arc shapes arranged at predetermined intervals. The bottom 9b may not necessarily be provided all around the lower portion of the outer wall 9a. The shapes of the outer wall 9a and the bottom 9b are not limited if the shape of the pressed portion can transmit the pressing force from the press fit 40.
(4) The position, shape, and number of the pressed portion 9d is not limited if the pressed portion 9d is provided in the engaging member 9.
(5) The magnetic circuit 2 and the holding member 11 may be fixed by insert molding or by forming the two integrally such as by press fitting or adhesion. The engaging member 9 may be adhered to the vibration member 20. An adhesion member for adhering the engaging member 9 and the vibration member 20 may be double-sided adhesive tape or adhesive.
(6) In the above embodiments, the pressed portion 9d is pressed by the separate press fit 40 to fix the engaging member 9 to the vibration member 20, however, a pressing portion such as protrusion that abuts the pressed portion 9d of the engaging member 9 to press the engaging member 9 may be provided to a part of the magnetic circuit 2 or a part of the holding member 11 of the magnetic circuit 2 instead of the press fit 40.

### REFERENCE SIGN

1: exciter
2: magnetic circuit
2a: insertion portion
3: voice coil
4: yoke
5: magnet
6: pole piece
7: damper
8: coil bobbin
9: engaging member
9a: outer wall
9b: bottom
9c: protrusion
9d: pressed portion
9e: engaging portion
11: holding member
12: magnetic circuit mounting portion
20: vibration member
20a: voice coil mounting portion
21: engaged member
22: convex portion
23: vibration surface
24: non-vibration surface
25: dividing portion
26: positioning portion
27: engaging hole
40: press fit

1. An exciter comprising:
a magnetic circuit fixed to a holding member;
a voice coil; and
an engaging member mounted to the voice coil;
wherein the engaging member includes:
an engaging portion engaging to an engaged portion provided to a vibration member, and
a pressed portion to engage the engaging portion and the engaged portion.

2. The exciter according to claim 1, further comprising:
an insertion portion for a press fit that is capable of pressing the pressed portion.

3. The exciter according to claim 2, wherein
the insertion portion is a through hole penetrating a central portion of the magnetic circuit.

4. The exciter according to claim 1, further comprising:
a pressing portion that presses the pressed portion, being provided in the magnetic circuit or the holding member of the magnetic circuit.

5. The exciter according to claim 1, wherein
the engaging member includes:
an outer wall to which the voice coil is mounted;
a bottom, abutting with the vibration member; and
a protrusion, protruding toward the magnetic circuit,
wherein the pressed portion is provided in the protrusion.

6. The exciter according to claim 5, wherein
the engaging portion is formed on the outer wall of the engaging member.

7. The exciter according to claim 1, further comprising:
a cushioning material, formed on a surface of the engaging member.

8. The exciter according to claim 1, wherein
the voice coil is supported by the holding member by a damper.

9. A speaker comprising:
a vibration member, including the engaged portion; and
the exciter according to claim 1, being mounted on the vibration member.

10. The speaker according to claim 9, wherein
the engaging portion is constructed by an engaging claw or an engaging hole, and
the engaged portion is constructed by an engaging hole or an engaging claw corresponding to the engaging portion.

11. The speaker according to claim 9, wherein:
the engaged portion is formed by a voice coil mounting portion protruding from the vibration member, and
the engaging member is attached to the voice coil mounting portion.

12. The speaker according to claim 9, wherein
a concaved portion or a convex portion is formed on a bottom of the engaging member and/or the vibration member.

13. The exciter according to claim 3, wherein
the engaging member includes:
an outer wall to which the voice coil is mounted;
a bottom, abutting with the vibration member; and
a protrusion, protruding toward the magnetic circuit,
wherein the pressed portion is provided in the protrusion.

14. The exciter according to claim 13, wherein
the engaging portion is formed on the outer wall of the engaging member.

15. The exciter according to claim 4, wherein
the engaging member includes:
an outer wall to which the voice coil is mounted;
a bottom, abutting with the vibration member; and
a protrusion, protruding toward the magnetic circuit,
wherein the pressed portion is provided in the protrusion.

16. The exciter according to claim 15, wherein
the engaging portion is formed on the outer wall of the engaging member.

17. The exciter according to claim 3, further comprising:
a cushioning material, formed on a surface of the engaging member.

18. The exciter according to claim 4, further comprising:
a cushioning material, formed on a surface of the engaging member.

19. The exciter according to claim 5, further comprising:
a cushioning material, formed on a surface of the engaging member.

20. The exciter according to claim 6, further comprising:
a cushioning material, formed on a surface of the engaging member.
